(19) United States
(12) Patent Application Publication
(10) Pub. No.: US 2007/0037092 A1
(43) Pub. Date: Feb. 15, 2007

(54) METHOD FOR MANUFACTURING OPTICAL RECORDING MEDIUM

(75) Inventors: Masahito Konishi, Yokohama-shi (JP); Ryuichi Yokoyama, Yokohama-shi (JP); Kyosuke Deguchi, Yokohama-shi (JP); Kuniyuki Morita, Sanda-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/461,209

(22) Filed: Jul. 31, 2006

(30) Foreign Application Priority Data
Aug. 9, 2005 (JP) 2005-230842 (PAT.

(51) Int. Cl. G11B 7/24

(52) U.S. Cl. 430/270.11

(57) ABSTRACT

A method for manufacturing a multi-layer optical recording medium that allows a transferring substrate to be reused is provided. The manufacturing method includes the steps of: forming a pattern with recesses and projections on a surface of a photopolymerizable (2P) resin layer, which is applied on a flat transferring substrate; forming a first recording layer on the pattern with the recesses and the projections; attaching the 2P resin layer and the first recording layer on a supporting substrate of the optical recording medium; and removing the transferring substrate from the 2P resin layer. The removed transferring substrate can be reused.

### BACKGROUND OF THE INVENTION

1. Field of the Invention

The present invention relates to a method for manufacturing an optical recording medium, which has a plurality of recording layers.

2. Description of the Related Art

Optical recording media are being used to record various pieces of information in the fields of computers, audiovisuals, and the like. Since mobile computers are now widely used to process many types of information, compact and capacious optical recording media are needed.

The substrate of such recording media have pits, pregrooves, or a pattern with fine recesses and projections for data (hereinafter, referred to as a signal pattern) for recording or reproducing information using light, whereby tracking servo signals or the like can be obtained. Conventionally, in a single-plate optical recording medium, a recording layer or a reflection layer is formed on the signal pattern or the like, and then an organic protection layer is formed thereon. Alternatively, two substrates are attached to each other with the recording layer or the reflection layer on one substrate facing the other substrate.

Along with the demand for increasing the density of the media, the use of a light source having a short wavelength to increase linear density has been suggested, and products have been manufactured accordingly. In addition, the use of the short wavelength light source has increased track density.

Alternatively, a recording medium in which a plurality of recording layers are formed on the surface of the substrate has been suggested. Unlike the single-plate or the attached recording medium with only one recording layer on one of the surfaces of the substrate, such a recording medium has a plurality of recording layers. A recording layer composed of a plurality of recording films, including a recording film, a conductive film, and the like, is formed on the substrate on which the signal pattern has already been formed. Then, another recording layer, including a recording layer, a conductive film, and the like, is formed on the former recording layer, with a signal pattern formed layer disposed therebetween. Thus, such an optical recording medium has a plurality of recording layers on one of the surfaces of the substrate and is manufactured by alternatively and repeatedly forming the signal pattern formation layer and the recording layer as necessary, and then forming an organic protection layer on the recording layer. Even in a recording medium in which a recording layer includes a single layer film, or in a recording medium like a ROM, in which a reflection layer is formed, a recording medium with a plurality of layers similar to the aforementioned example can be formed. The light incident surface for recording, reproducing and deleting information can be either the surface of the substrate or the surface of the organic protection layer on the recording layer. In addition, one of the surfaces or both surfaces can be used as the light incident surfaces. In particular, the thickness of a light-transmissive substrate can be easily reduced if the organic protection layer is the light incident surface. Accordingly, NA (numerical aperture) of an objective lens that reads the information from the media can be increased, thereby being advantageous in promoting an increase in density.

A method of forming the plurality of recording layers on one of the surfaces of the substrate is disclosed in Japanese Patent Laid-Open No. 2003-115130.

However, when recording or reproducing information through the organic protection layer, as discussed below, a serious problem may occur in manufacturing the optical recording medium with a plurality of recording layers.

Conventionally, a plurality of recording layers is formed by a photopolymerization (2P) method.

In FIG. 7, a schematic illustration of a manufacturing method using the 2P method is shown. A description with reference to FIG. 7 is provided.

(1) A signal pattern is transferred to a substrate, which becomes a supporting substrate, with a stamper 7 by injection molding.

(2) A supporting substrate 1 is formed.

(3) A first-layer-section recording layer 5 is formed on the signal pattern.

(4) At the same time, a transparent stamper 8 for forming a second-layer-section signal pattern is injection molded with the stamper 7.

(5) The transparent stamper 8 is formed.

(6) A photopolymerizable (2P) resin layer 3 is applied on the recording layer 5, and the transparent stamper 8 is attached to the 2P resin layer 3 as the second-layer-section, forming the second-layer-section signal pattern.

(7) The transparent stamper 8 is removed.

(8) A second-layer-section recording layer 6 is formed on the second-layer signal pattern.

(9) Then, an organic protection layer 14 is formed, and consequently, a two-layer optical recording medium is completed.

The above-described method can be used when manufacturing a multi-layer medium having more than two layers. Thus, the multi-layer optical recording medium may be manufactured by forming the recording layer 6, then forming a transparent stamper 8 to be located in an upper layer by the 2P method in the same manner as described above, followed by repeating the steps as necessary. The transparent stamper 8 is a transparent substrate, which is formed using a stamper 7 by injection molding. Therefore, the transparent stamper 8 transfers a signal pattern to the recording layer 5 to form a signal pattern surface with the 2P resin layer 3 interposed therebetween.

However, according to this method, the transparent stamper 8 needs to be injection molded for each required layer. Therefore, as many injection-molding devices as layers have to be prepared to construct a production line, increasing the equipment and the manufacturing costs.

In addition, as shown in (10) of FIG. 7, the transparent stamper 8 is discarded after being used only once, because it may be damaged in the removal process. This particular issue does not allow the manufacturing costs to be reduced. Meanwhile, there is a step of forming an organic protection layer 14, which is also called a cover layer, on the outermost surface. This step is performed by spin coating or by attaching a sheet, and it needs to be performed with a high level of dimensional precision with a tolerance of only ±2 μm, which may be extremely difficult and can prevent the improvement in production efficiency.

### SUMMARY OF THE INVENTION

The present invention provides a method for manufacturing a multi-layer recording medium, which allows a transferring substrate to be reused.

In particular, a manufacturing method of an optical recording medium in accordance with one aspect of the present invention includes the steps of: forming a pattern with recesses and projections on a surface of a photopolymerizable (2P) resin layer, which is applied to a flat surface of a transferring substrate; forming a first recording layer on the pattern with the recesses and the projections; attaching the 2P resin layer and the first recording layer on a supporting substrate of the optical recording medium; and removing the flat transferring substrate from the 2P resin layer, wherein the flat transferring substrate removed from the 2P resin layer is reusable.

Other features of the present invention will become apparent from the following description of exemplary embodiments with reference to the attached drawings.

### BRIEF DESCRIPTION OF THE DRAWINGS

FIG. 1 is a schematic illustration showing the steps of forming a recording layer or a reflection layer according to a first embodiment of the present invention.

FIG. 2 is a schematic illustration showing the steps of forming a recording layer or a reflection layer according to a second embodiment of the present invention.

FIG. 3 is a schematic illustration showing the steps of forming a stamper.

FIGS. 4A and 4B are schematic cross-sectional views of multi-layer optical recording media according to the first and second embodiments of the present invention.

FIG. 5A is a schematic illustration showing an attachment step.

FIG. 5B is a cross-sectional view of substrate holder jigs according to the embodiments of the present invention.

FIG. 6 is a schematic illustration showing a removal step according to the embodiments of the present invention.

FIG. 7 is a schematic illustration showing the steps of forming a recording layer or a reflection layer according to a conventional 2P method.

### DESCRIPTION OF THE EMBODIMENTS

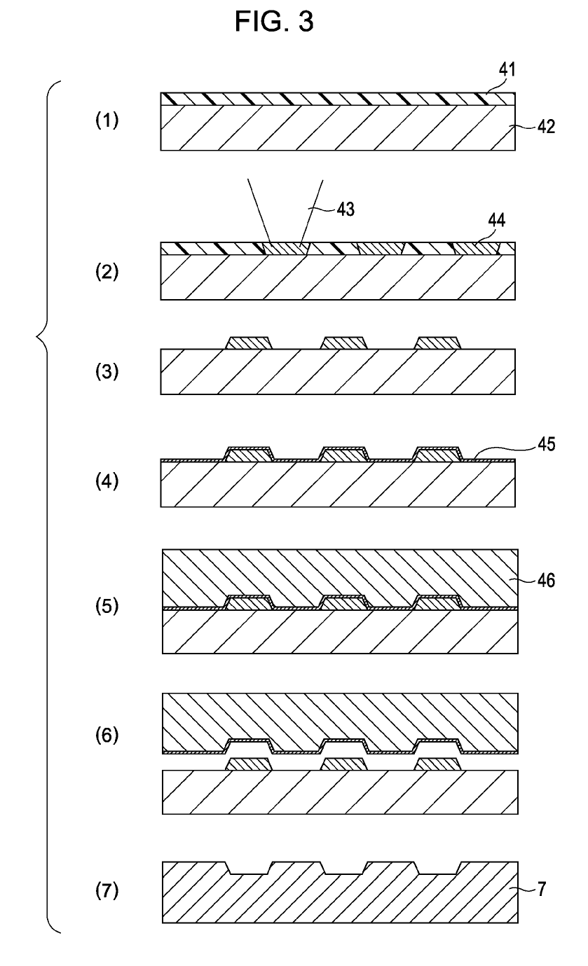

Embodiments of the present invention are described below in detail with reference to the drawings. A manufacturing method of a stamper as a precision tool, which is used for transferring a pattern with recesses and projections, will be described with reference to FIG. 3.

FIG. 3 is an illustration showing a manufacturing method of the stamper for forming a signal pattern, which is used in the embodiments of the present invention.

(1) A photoresist 41 is applied on a master glass 42 by spin coating.

(2) A predetermined signal pattern is exposed to laser beam 43.

(3) An exposed part 44 is developed using an alkaline solution, so that the signal pattern is formed on the master glass 42.

(4) A nickel conductive film 45 is formed on the surface of the signal pattern by sputtering.

(5) An electroformed layer 46 is formed by nickel electroforming. The thickness of the electroformed layer 46 is 0.3 mm. Then, the entire back surface is polished.

(6) The nickel conductive film 45 is removed from the master glass 42. Thus, the stamper 7, provided with the predetermined signal pattern, is formed as shown in (7).

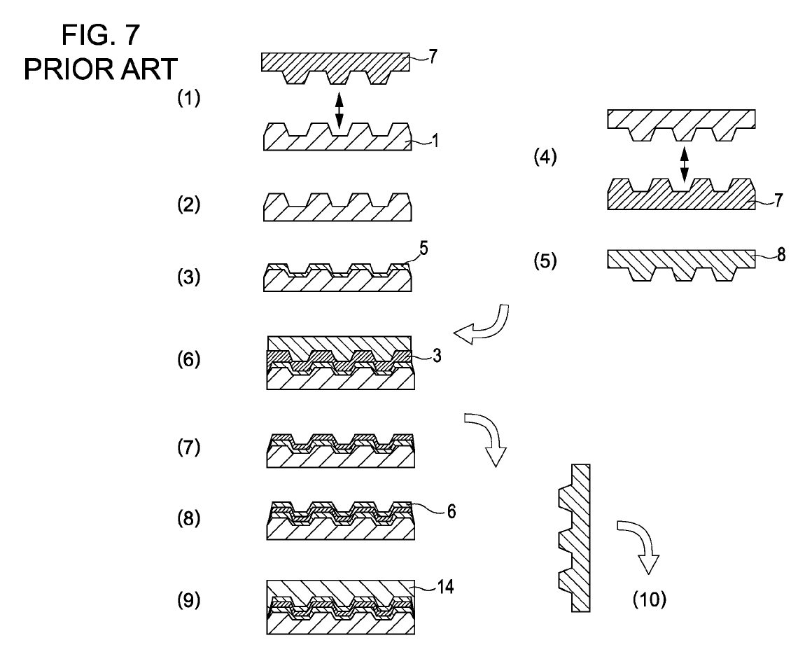

As mentioned above, with the manufacturing method of the optical recording medium according to the embodiments of the present invention, the Ni stamper 7 is formed, which can be used like a conventional stamper, and unlike a conventional stamper, can also be repeatedly reused. Thus, there is no need to use a resin transparent stamper 8, as shown in FIG. 7 and discussed above, which stamper may have to be discarded each time a layer is formed.

A manufacturing method according to the present invention is described below with reference to the drawings.

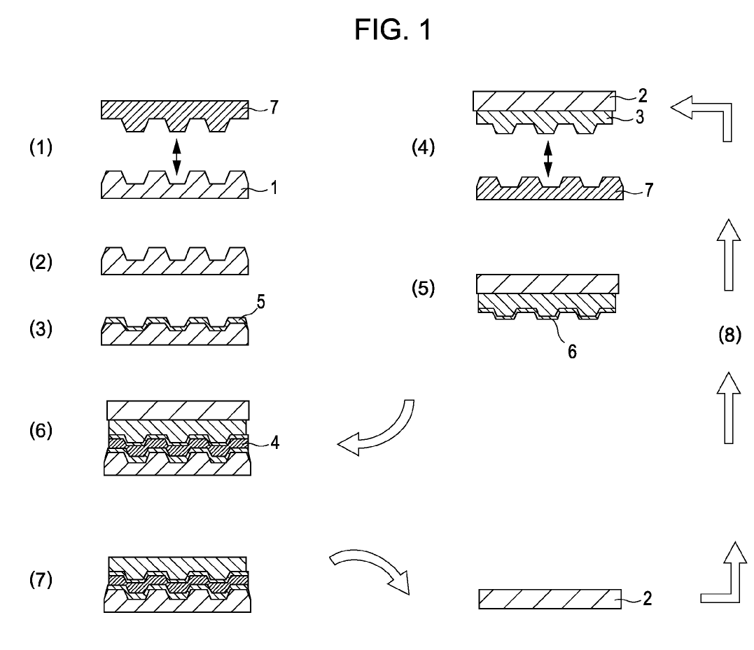

FIG. 1 is a schematic illustration showing the steps of forming each recording layer according to a first embodiment. The numbering in FIG. 1 corresponds to that assigned to the following steps, respectively.

First, the stamper 7 for forming a signal pattern is prepared. This stamper may be prepared by a method as shown above.

(1) The stamper 7 transfers a signal pattern to the supporting substrate 1, which is formed by injection molding.

(2) The supporting substrate 1 is thus formed. Since the optical laser for recording or reproducing information need not be incident on the supporting substrate 1, the optical characteristics thereof are not considerably important. However, the material of the supporting substrate 1 can be mechanically stable in its dimensions and less hygroscopic. In addition, due to the provision of the signal pattern, it must be able to transfer the signal pattern with a high level of precision. The specific base material can be a polycarbonate resin, polyolefin resin or acrylic resin, but the material is not limited thereto. Also, the substrate can be formed by injection molding to control the cost, but the forming method is not limited thereto.

The supporting substrate 1, to which the signal pattern is transferred, is then transported to a deposition device (not shown).

(3) In the deposition device, a recording layer or reflection layer 5 is deposited by sputtering or the like on the surface on which the signal pattern has already been formed. Alternatively, the deposition may be performed by evaporating, CVD, dipping, spin coating, or the like, as long as the method is suitable for production using machines, and recording media can be manufactured.

Materials that can be used to form an optical recording layer include well-known materials, such as alloys or the like made of at least one of Te, In, Ga, Sb, Se, Pb, Ag, Au, As, Co, Ni, Mo, W, Pd, Ti, Bi, Zn, Si and the like. Materials that can be used to form a magneto-optical recording layer include those widely utilized for this purpose, such as alloys made of at least one of Tb, Fe, Co, Cr, Gd, Dy, Nd, Sm, Ce, Ho, and the like; or rare earth-transition metal alloys. Many of these materials are well-known in the related arts. Materials that can be used to form a reflection layer include, for example, Al, an Al alloy, Si, SiN, Ag, an Ag alloy, or the like. Many of these materials are well-known in the related arts. Further, organic coloring materials, such as those of a cyanine type, a phthalocyanine type, an azo type, or the like, may be used for the recording layer. The thickness of the recording layer or reflection layer may be arbitrarily set. However, since the light is attenuated when entering the light incident surface and advancing toward the recording layer or reflection layer, the light transmittance can be increased. Further, the composition and the thickness of the recording layer or reflection layer can be adjusted so as to record, reproduce or delete information without any problems. By optimizing the composition, thickness, deposition conditions, and the like for each of the recording layers or reflection layers 5 and 6 (described layer), the recording layers or reflection layers with the desired transmittance and reflectance can be formed. This embodiment of the present invention employs the material suitable for the desired optical recording medium, and the material is not limited to that described above.

(4) Next, a flat substrate 2 (hereinafter, referred to as a transferring substrate) for transferring the signal pattern by the 2P method is prepared. The transferring substrate 2 is a flat mirror substrate without any signal pattern on both surfaces. Accordingly, the transferring substrate 2 does not necessitate that use of a molding device for each of the necessary layers, and the substrate can be formed more easily than when the conventional transparent stamper 8 is used. The transferring substrate 2 is preferably made of material that allows curing UV light to pass through the substrate. In Example 3 of the present invention, the use of a glass substrate as the transferring substrate was examined. In terms of flatness, smoothness and the ability to be reused, the glass substrate is better than the injection molded transferring substrate 2.

When the transferring substrate 2 formed by injection molding is used, it is deaerated for 30 minutes or longer, and then the signal pattern is transferred by the 2P method. When the transferring substrate 2 is made of glass (stamper 7), its surface is polished with fine polishing particles and washed in front end processes, and then the signal pattern is transferred by the 2P method.

In the transferring step, the thickness of the 2P resin layer 3 can be adjusted so that it can be used as an organic protection layer for the inner layer and the outermost layer. In addition, the eccentricity of the stamper 7 can be adjusted with reference to that of the transferring substrate 2, so that the alignment may be easily performed in a back end process. The adjustment of the eccentricity may be performed by using various methods, for instance, by adjusting with a jig, by utilizing image processing, and the like.

In addition, an alignment mark (not shown) may be added outside of the data area when the signal pattern is transferred, so that the alignment in the back end process can be more easily performed. Alternatively, a unique profile may be provided on the signal pattern surface or the substrate surface to facilitate the back end process and to improve the substrate characteristics.

(5) Then, in the deposition device, similarly to the supporting substrate 1, a desired reflection layer or recording layer 6 is deposited on the transferring substrate 2 with the signal pattern.

(6) Then, the supporting substrate 1 and the transferring substrate 2 are attached to each other. More specifically, an adhesive layer (adhesive) 4 for the attachment is applied on the surface of the transferring substrate 2. UV light can be irradiated onto the transferring substrate 2. While the UV-curable resin is used in the embodiment of the present invention, the adhesive layer 4 may be composed of a cationic adhesive, a heat-curable adhesive, a two-part adhesive, a hot-melt adhesive, a pressure-sensitive adhesive, or the like. The adhesive layer 4 is not limited to the materials described above, as long as the specifications needed for the optical recording medium, such as light transmittance and reflectance, are provided. In addition, while in this embodiment a spin coating method is employed, various other methods, such as dipping, roll coating, attaching a sheet, and adjusting the thickness with the use of a blade, can be used. In fact, any methods can be employed, as long as the distribution in the adhesive layer 4 plane satisfies the desired standard. The supporting substrate 1 is superimposed on the transferring substrate 2, and then the substrates are UV-cured. During the attachment and curing, a vacuum attachment device, or another similar device, is used to prevent air or foreign matter from entering the space between the layers. In addition, pressure can be applied from the upper and lower sides to keep the substrates horizontal and parallel to each other. Further, a mechanism for holding and aligning the substrates can be provided, so that the substrates do not become misaligned with respect to each other in a superimposed position. Further, the positional accuracy of the substrates may be increased if the alignment mechanism is provided in the attachment device.

(7) Next, a removal step is described. Specifically, in this step, the transferring substrate 2 is removed from the 2P resin layer 3. At this time, mechanical removal is easy and appropriate. A unique profile may be made on the substrate. For example, a trigger scratch may be made with a claw-like structure on the outer periphery or the inner periphery of the transferring substrate 2, and then the substrate may be removed by air blowing, or a profile, which allows a trigger to be easily made may be provided on the transferring substrate 2. Alternatively, there is another known method that involves the use of polymethyl methacrylate (PMMA), which is typically employed in the manufacturing of DVD-18, as the material for the substrate. Various other materials and methods can be used. In addition, since the mirror substrate without any signal pattern provided on both surfaces is used in the present invention, the signal pattern on the surface of the transparent stamper will not be damaged during the removal, unlike in conventional methods. Accordingly, the mirror substrate may be reused, as shown in (8), thereby being advantageous in that it decreases the manufacturing costs.

At the same time, if the 2P resin layer 3 has the same thickness as that of the organic protection layer 14, the step of attaching the organic protection layer 14 can be omitted.

Since the removal probably causes electrostatic changing, the antistatic effect can be further ensured by static-free air blowing, applying an antistatic agent, applying a protection coating on the outermost layer, or the like.

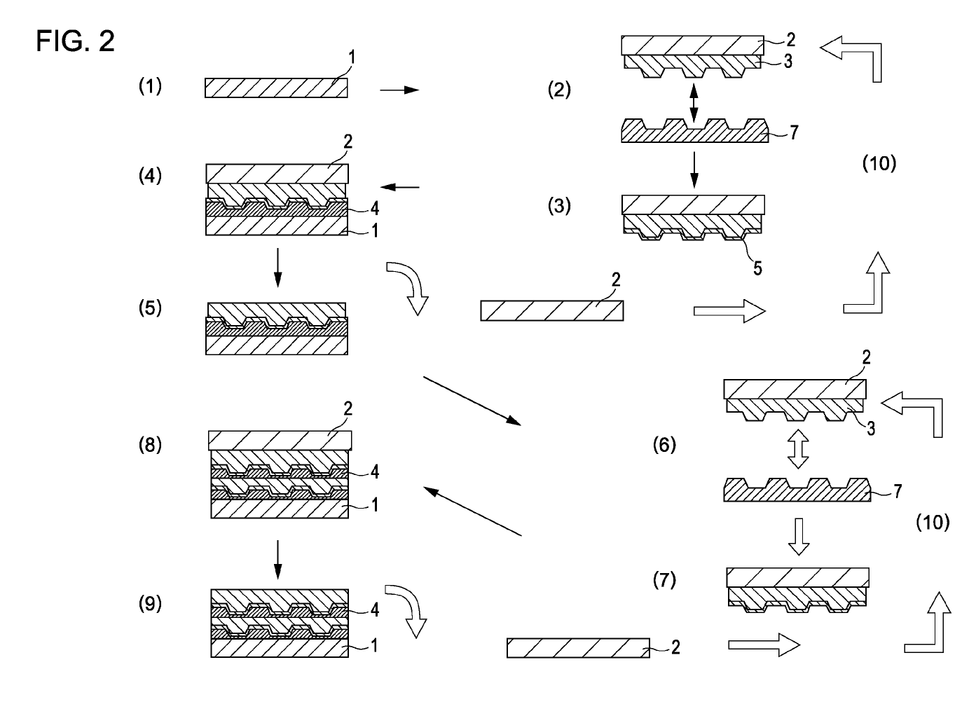

FIG. 2 is a schematic illustration showing the steps of forming each recording layer according to a second embodiment.

First, the stamper 7 for forming a signal pattern is prepared.

(1) The mirror substrate is prepared as the supporting substrate 1. The substrate is flat and has no recesses or projections. The material of the substrate can be mechanically stable in its dimensions and less hygroscopic. The specific base material can be polycarbonate resin, polyolefin resin or acrylic resin, but it is not limited thereto. Also, in view of the cost, the substrate can be formed by injection molding, but the forming method is not limited thereto.

(2) A first-layer-section transferring substrate 2 is prepared. A pattern with recesses and projections is transferred to the transferring substrate 2 by the 2P method with the stamper 7. The transferring substrate 2 is a flat mirror substrate without any signal pattern on both surfaces. Accordingly, the transferring substrate 2 does not need a molding device for each of the necessary layers, and the substrate can be formed more easily than the conventionally used transparent stamper 8. The transferring substrate 2 is preferably made of a material that allows curing UV light to pass through the substrate. In Example 3 of the present invention, the use of a glass substrate as the transparent substrate 2 was examined. In terms of flatness, smoothness and the ability to be reused, the glass substrate is better than the injection-molded transferring substrate 2.

When the transferring substrate 2 formed by injection molding is used, it is deaerated for 30 minutes or longer, and then the signal pattern is transferred by the 2P method. When the transferring substrate 2 made of glass (stamper 7) is used, its surface is polished with the fine polishing particles and washed in the front end processes. Then, the signal pattern is transferred by the 2P method.

In the transferring step, the 2P resin layer 3 can be used for the inner layer and the outermost layer by adjusting its thickness. In addition, the eccentricity of the stamper 7 can be adjusted with reference to that of the transferring substrate 2, so that alignment may be easily performed in the back end process. The adjustment of the eccentricity may be performed by using various methods, for instance, by adjusting with a jig, by utilizing image processing, and the like. In addition, an alignment mark may be added outside of the data area when the signal pattern is transferred, so that the alignment in the back end process can be more easily performed. Alternatively, a unique profile may be provided on the signal pattern surface or the substrate surface to facilitate the back end process and to improve the substrate characteristics.

(3) The first-layer-section transferring substrate 2 is transported to the deposition device, and then a recording layer 5 is deposited. In the deposition device, the recording layer or reflection layer 5 is deposited by sputtering or the like on the surface on which the signal pattern has already been formed. The thickness of the recording layer or reflection layer may be arbitrarily set. However, since the light is attenuated when entering the light incident surface and advancing toward the recording layer or reflection layer, light transmittance toward the incident surface can be increased. Further, the composition and the thickness of the recording layer or reflection layer can be adjusted so as to record, reproduce or delete information without any problems. By optimizing the composition, thickness, deposition conditions, and the like for each of the recording layers or reflection layers 5 and 6 (described layer), the recording layers or reflection layers with the desired transmittance and reflectance can be formed. This embodiment of the present invention employs materials suitable for the desired optical recording medium, and the materials are not limited to those described above.

(4) Then, the supporting substrate 1 and the transferring substrate 2 are attached to each other. More specifically, the adhesive layer 4 for the attachment is applied onto the surface of the transferring substrate 2. The supporting substrate 1 can be irradiated with UV light. While the UV-curable resin is used in the embodiment of the present invention, the adhesive layer 4 may be composed of a cationic adhesive, a heat-curable adhesive, a two-part adhesive, a hot-melt adhesive, a pressure-sensitive adhesive, or the like. However, the material of the adhesive layer 4 is not limited to those described above, as long as the specifications needed for the optical recording medium, such as the light transmittance and reflectance, are provided. In addition, while in this embodiment of the present invention a spin coating method is employed, various other methods, such as dipping, roll coating, attaching a sheet, and adjusting the thickness with the use of a blade, can be used. In fact, any methods can be employed, as long as the distribution in the adhesive layer 4 plane satisfies the desired standard. The supporting substrate 1 is superimposed on the transferring substrate 2, and then the substrates are UV-cured. During the attachment and curing, the vacuum attachment device can be used to prevent air or foreign matter from entering the space between the layers. Alternatively, a device similar to the one described above may be used, and pressure can be applied from the upper and lower sides to keep the substrates horizontal and parallel to each other. Further, a mechanism for holding and aligning the substrates can be provided, so that the substrates do not become misaligned with respect to each other in the superimposed position. Further, the positional accuracy of the substrates may be increased if the alignment mechanism is provided in the attachment device.

(5) the removal step according to the manufacturing method of the multi-layer optical recording medium is described below. The transferring substrate 2 is removed from the 2P resin layer 3. At this time, mechanical removal is easy and appropriate. A unique profile may be made on the substrate to assist in the removal process. For example, a trigger scratch may be made with a claw-like structure on the outer periphery or the inner periphery of the transferring substrate 2, and then the substrate may be removed by air blowing, or a profile which allows a trigger to be easily made, may be provided on the transferring substrate 2. Alternatively, there is another known method, which involves using PMMA as the material for the substrate, as discussed above. Various other materials and methods can be used. In addition, since the mirror substrate without any signal pattern provided on both surfaces is used in the embodiment of the present invention, the signal pattern on the surface of the transparent stamper will not be damaged during the removal, unlike in conventional methods. Accordingly, the mirror substrate may be reused as shown in (10), thereby being advantageous in that it at least decreases the manufacturing costs.

(6) A second-layer-section transferring substrate 2 (which may be equivalent to the first-layer-section transferring substrate 2) is prepared. Similar to the first-layer-section transferring substrate 2, a pattern with recesses and projections is transferred to the transferring substrate 2 by the 2P method.

(7) Similar to the first-layer-section transferring substrate 2, a recording layer 6 is deposited on the pattern with the recesses and the projections of the second-layer-section transferring substrate 2.

(8) Then, similar to the first-layer-section transferring substrate 2, the supporting substrate 1 and the second-layer-section transferring substrate 2 are attached to each other.

(9) Next, similar to the first-layer-section transferring substrate 2, the second-layer-section transferring substrate 2 is removed from the 2P resin layer 3.

At the same time, if the 2P resin layer 3 has the same thickness as the organic protection layer 14, the step of attaching the organic protection layer 14 can be omitted.

Since the removal probably causes an electrostatic charge, the antistatic effect can be further ensured by static-free air blowing, applying an antistatic agent, applying a protection coating on the outermost layer, or the like.

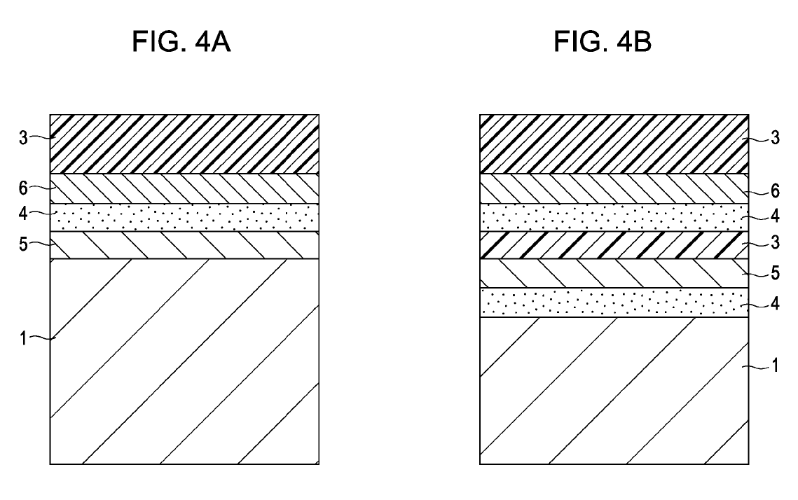

FIGS. 4A and 4B are illustrations, which schematically show the multi-layer optical recording media produced by the manufacturing methods of the multi-layer optical recording media according to the first and second embodiments of the present invention.

FIG. 4A is a schematic illustration showing the configuration of the optical recording medium, which is manufactured according to the first embodiment.

The first-layer-section recording layer 5 is formed on the supporting substrate 1. Then, the adhesive layer 4 is disposed on the recording layer 5, and the recording layer 6 and 2P resin layer 3 of the second-layer-section are formed on the adhesive layer 4. The 2P resin layer 3 also serves as the organic protection layer.

FIG. 4B is a schematic illustration showing the configuration of the optical recording medium, which is manufactured according to the second embodiment.

The adhesive layer 4 is disposed on the supporting substrate 1. Then, the recording layer 5 and the 2P resin layer 3 of the first-layer-section are formed on the adhesive layer 4, and another adhesive layer 4 is disposed on the resin layer 3. Then, the recording layer 6 and the 2P resin layer 3 of the second-layer-section are formed on the second adhesive layer 4. The 2P resin layer 3 also serves as the organic protection layer.

Examples of the manufacturing in accordance with the embodiments of the present invention are described below.

### EXAMPLE 1

The optical recording medium was formed according to the first embodiment.

The supporting substrate 1 was formed with the stamper 7 using the injection-molding device. The formed substrate was 1.1 mm in thickness, φ120 mm in outer diameter, and φ15 mm in inner diameter. A polycarbonate resin was used as a thermoplastic resin. The formed supporting substrate 1 was transported to the deposition device, and an Ag alloy was deposited as the reflection layer 5.

In addition, similar to the former step, the stamper 7 without any signal pattern was attached to the injection-molding device, and then the transferring substrate 2 was formed. Similar to the former step, the polycarbonate resin was used.

Next, the stamper 7 transferred the signal pattern to the 2P resin layer 3 applied on the transferring substrate 2. The transferring substrate 2 was deaerated for 30 minutes. The eccentricity of the substrate was adjusted with the jig with reference to the inner diameter of the stamper 7.

The 2P resin layer 3 used in this case was INC-118 manufactured by Nippon Kayaku Co., Ltd. The thickness of the 2P resin layer 3 was 70 μm. Similar to the former step, the transferring substrate 2 obtained at this time was transported to the deposition device, and an Ag alloy was deposited as the reflection layer 6.

Then, the UV-curable adhesive layer 4 was applied on the reflection layer 6 formed on the transferring substrate 2 by spin coating. The thickness of the adhesive layer 4 was 25 μm.

Then, the supporting substrate 1 and the transferring substrate 2 were transferred to the vacuum attachment device 10.

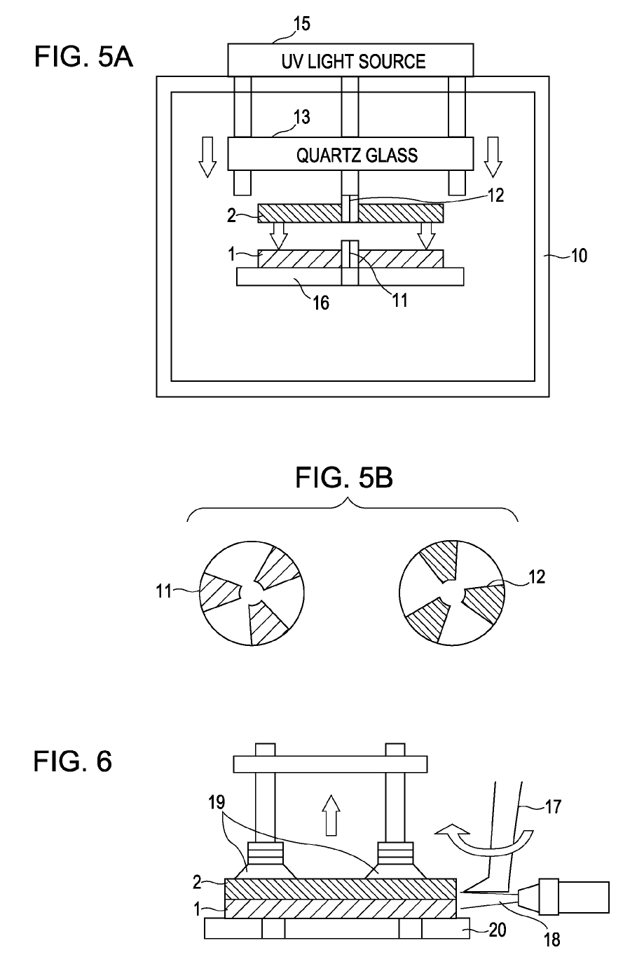

The attachment step is described below with reference to FIGS. 5A and 5B.

As shown in FIG. 5A, the supporting substrate 1 was supported below the transferring substrate 2 in a vacuum while the inner peripheries thereof were fixed with chuck jigs (lower chuck jig 11 and upper chuck jig 12). Then, these substrates were attached to each other. The supporting substrate 1 was put on a lower holder jig 16, and the eccentricity thereof was adjusted by the lower chuck jig 11. The transferring substrate 2 was held by the upper chuck jig 12 at the inner periphery thereof, so that the eccentricity thereof was adjusted.

When the vacuum reached a certain level, the upper chuck jig 12 moved downward so that the supporting substrate 1 was attached to the transferring substrate 2.

Since a pressing quartz glass 13 was disposed above both substrates, the combined thickness of the substrates was adjusted according to a pushing distance while pressure was applied to the substrates with the quartz glass 13 after the attachment.

Then, UV light was irradiated from a UV light source 15 to cure the adhesive layer 4 in the device.

FIG. 5B is a cross-sectional view showing chuck parts of the upper and lower chuck jigs 12 and 11.

The positional relationship of the chuck parts is described below.

The chuck parts include three upper claws and three lower claws, respectively, which are movable for chucking and centering the substrates. When the eccentricities of the substrates are adjusted for the alignment, the claws may expand radially outward from a shape in which the claws are closely inwardly arranged to each other, to allow the eccentricities of the substrates to be aligned. When the eccentricities of the substrates are adjusted with reference to the signal pattern during injection molding, and when the signal pattern is transferred thereto by the 2P method, centering the substrates in the step of the attachment can align the eccentricities in a highly precise manner.

Further, the upper and lower chuck jigs 12 and 11 are adjusted in advance in a highly precise manner. The attachment employs a mechanism in which the substrates will not interfere with each other even when they are vertically superimposed. Therefore, the alignment in the eccentricities of the substrates, the downward movement, and the attachment of the substrates can be performed.

Then, after the substrates were transported to a removal device, removal was performed.

The removal step is described below with reference to FIG. 6.

The substrates attached to each other were fixed at a substrate holder jig 20. The fixing was performed by vacuum suction. After the substrates were fixed at the substrate holder jig 20, a mechanical claw 17 applied a force to the outer peripheral face of the transferring substrate 2, and air flow 18 was applied thereto at the same time as the claw 17 rotated. In addition, autohands 19 supported the transferring substrate 2 by vacuum suction so as to fix the transferring substrate 2 when it was removed and to collect the transferring substrate 2 after the removal.

When the air flow 18 was started and the transferring substrate 2 was moved upward, the autohands 19 started to move the substrate up. The air flow 18 in this case was provided by a static-free gun, which provided static-free air for the removal. When the removal was completed, the autohands 19 collected the substrate in a magazine for collecting the substrate.

Then, the outermost surface of the supporting substrate 1 was coated with the protection coating (not shown) for increasing the antistatic effect. The material used for the protection coating was EX-730 manufactured by Dainippon Ink and Chemicals, Incorporated.

As described above, the two-layer optical recording medium was manufactured.

The manufactured two-layer optical recording medium was reproduced through the surface of the protection coating layer. The reproduction was successful without any problems found in the layers. The transferring substrate was reused in the method similar to the one described above, and the multi-layer optical recording medium having more than two layers was manufactured. The reproduction was successful and was performed without any problems.

### EXAMPLE 2

The optical recording medium was manufactured according to the second embodiment. The optical recording medium was manufactured in a similar manner to the one described in Example 1. In this example, however, the mirror substrate was used as the supporting substrate 1. In addition, two transferring substrates 2, i.e., an A substrate and a B substrate, were used. The thickness of the 2P resin layer 3 on the A substrate was 10 μm, while that on the B substrate was 70 μm. The A substrate was attached to the supporting substrate 1 (mirror substrate), i.e., to the first-layer-section and then removed, and then the B substrate was attached to the second-layer-section and then removed. At this time, the adhesive was applied for the attachment, and the application amount thereof was adjusted so that the thickness of the adhesive layer 4 between the supporting substrate 1 and the A substrate was 10 μm, while that between the supporting substrate 1 and the B substrate was 15 μm after the removal of the A substrate. A two-layer optical recording medium thus manufactured was reproduced through the surface of the protection coating without any problems. With the method similar to the one described above, the transferring substrate was reused, and the multi-layer optical recording medium having more than two layers was manufactured. The reproduction was successful and was performed without any problems.

### EXAMPLE 3

The optical recording medium was manufactured in a similar manner to that in Example 1. In this example, however, a glass substrate was used as the transferring substrate. In the front end processes, the surface of the glass substrate was washed with toothpaste, dried at 90° C. for 30 minutes in a clean oven, and then it was ensured that the glass substrate cooled to room temperature. Then, the signal pattern was transferred thereto by the 2P method.

The two-layer optical recording medium thus manufactured was reproduced in a similar manner through the surface of the protection coating without any problems. The transferring substrate was reused in the method similar to the one described above, and the multi-layer optical recording medium having more than two layers was manufactured. The reproduction was successful and was performed without any problems.

While the present invention has been described with reference to exemplary embodiments, it is to be understood that the invention is not limited to these disclosed exemplary embodiments. The scope of the following claims is to be accorded the broadest interpretation so as to encompass all modifications, equivalent structures and functions.

This application claims the benefit of Japanese Application No. 2005-230842, filed Aug. 9, 2005, which is hereby incorporated by reference in its entirety.

What is claimed is:

1. A method for manufacturing an optical recording medium, the method comprising the steps of:
forming a pattern with recesses and projections on a surface of a photopolymerizable resin layer, which is applied on a flat transferring substrate;
forming a first recording layer on the pattern with the recesses and the projections;
attaching the photopolymerizable resin layer and the first recording layer on a supporting substrate of the optical recording medium; and
removing the flat transferring substrate from the photopolymerizable resin layer,
wherein the flat transferring substrate removed from the photopolymerizable resin layer is reusable.

2. The method according to claim 1, wherein the attaching step comprises the sub-steps of:
transferring a signal pattern to the supporting substrate using a transparent stamper;
forming a second recording layer on the signal pattern transferred to the supporting substrate; and
attaching the photopolymerizable resin layer on the second recording layer formed in the forming sub-step.

3. The method according to claim 1, wherein, in the attaching step, an adhesive is applied on a flat surface of the supporting substrate prior to the attachment.

4. The method according to claim 1, further comprising a step of reusing the flat transferring substrate removed in the removing step, the reusing step comprising the sub-steps of:
applying a new photopolymerizable resin layer on the flat transferring substrate;
forming the pattern with the recesses and the projections on the new photopolymerizable resin layer;
forming a new first recording layer on the pattern with the recesses and the projections formed on the new photopolymerizable resin; and
attaching the flat transferring substrate, on which the new first recording layer is formed, on a new supporting substrate of a new optical recording medium.
